(19) United States
(12) Patent Application Publication
(10) Pub. No.: US 2014/0187688 A1
(43) Pub. Date: Jul. 3, 2014

(54) (Meth)Acrylic Copolymer, Method for Preparing the Same and Thermoplastic Resin Composition Comprising the Same

(71) Applicant: CHEIL INDUSTRIES INC., Gumi-si (KR)

(72) Inventors: Joo Hyun JANG, Uiwang-si (KR); Kee Hae KWON, Uiwang-si (KR); Bo Eun KIM, Uiwang-si (KR); Yong Hee KANG, Uiwang-si (KR); Ja Kwan GOO, Uiwang-si (KR); Man Suk KIM, Uiwang-si (KR); Il Jin KIM, Uiwang-si (KR); Kwang Soo PARK, Uiwang-si (KR); Natarajan Senthilkumar, Uiwang-si (KR); Jo Won LEE, Uiwang-si (KR)

(21) Appl. No.: 13/929,105

(22) Filed: Jun. 27, 2013

(30) Foreign Application Priority Data
Dec. 28, 2012 (KR) 10-2012-0157666
Dec. 28, 2012 (KR) 10-2012-0157679

(51) Int. Cl. C08F 230/02; C08L 69/00

(52) U.S. Cl. CPC C08F 230/02; C08L 69/00
USPC 524/115; 526/275; 525/185; 525/67

(57) ABSTRACT

A (meth)acrylic copolymer is a copolymer of a monomer mixture including a phosphorus-based (meth)acrylic monomer represented by Formula 1, and a monofunctional unsaturated monomer. The (meth)acrylic copolymer can have improved refractive index, excellent flame resistance, transparency, scratch resistance and/or environment-friendliness:

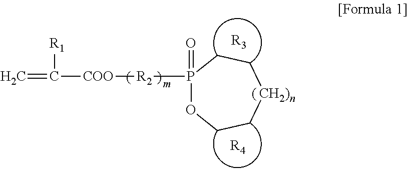

wherein R₁ is hydrogen or methyl, R₂ is a substituted or unsubstituted C1-C20 hydrocarbon group, R₃ and R₄ are the same or different and are each independently a substituted or unsubstituted C6-C20 cyclic hydrocarbon group, m is an integer from 1 to 10, and n is an integer from 0 to 5.

### CROSS-REFERENCE TO RELATED APPLICATION

This application claims priority under 35 USC Section 119 to and the benefit of Korean Patent Application 10-2012-0157666, filed Dec. 28, 2012, and Korean Patent Application No.10-2012-0157679, filed Dec. 28, 2012, the entire disclosure of each of which is incorporated herein by reference.

### FIELD OF THE INVENTION

The present invention relates to a (meth)acrylic copolymer, a method of preparing the same and a thermoplastic resin composition including the same.

### BACKGROUND OF THE INVENTION

Thermoplastic resins have a lower specific gravity than glass or a metal and can have excellent physical properties such as moldability and impact resistance, among others. Recently, there has been an increase in the manufacture of low-production-cost, larger and lighter electric and electronic products, In view of the same, plastic products formed using a thermoplastic resin are rapidly replacing many conventional products that include glass or metal and are widely used in a range of applications from electric and electronic products to automobile parts. Particularly, there is an increased demand for transparent resins in view of the trend towards thinner electric and electronic products and changes in design concepts. Accordingly, there is an increasing demand for a functional transparent material prepared by providing functionality such as scratch resistance or flame resistance to a conventional transparent resin.

As a conventional transparent scratch-resistant material, an acrylic resin such as poly(methyl methacrylate) (PMMA) is used. PMMA has excellent transparency, weather resistance, a mechanical strength, surface gloss and an adhesive strength, and particularly, very excellent scratch resistance, but has very poor impact resistance and flame resistance.

To maintain the excellent transparency and increase the impact resistance of PMMA, a method of using an acrylic impact reinforcing agent adjusted to have the same refractive index as that of PMMA is used. However, since the acrylic impact reinforcing agent has lower impact efficiency than a butadiene-based impact reinforcing agent, it does not have sufficient impact resistance.

In addition, there is a method of adding a flame retardant to reinforce the flame resistance of PMMA. However, according to this method, sufficient flame resistance may be difficult to obtain, physical properties such as thermal resistance and impact resistance may be degraded, and thermal stability may be degraded due to a flame retardant during processing. Accordingly, so far, there has been no report of a transparent acrylic resin achieving flame-retardancy alone.

In addition, among the thermoplastic resins, a polycarbonate (PC) resin has very excellent mechanical strength and flame resistance, excellent transparency and weathering resistance, and very good impact resistance and thermal stability, but has very poor scratch resistance.

To overcome the above problems and achieve mechanical properties including impact resistant and scratch resistant, a method of copolymerizing a high refractive index monomer, and a method of preparing a PC/PMMA resin by mixing polycarbonate with an acrylic resin, preferably, PMMA in the preparation of a PMMA resin were developed. In addition, to prepare a highly-compatible PC/PMMA resin, a polycarbonate/acrylic alloy resin having high scratch resistance and employing an acrylic copolymer having a high refractive index was developed. However, the conventionally-developed copolymer into which a high refractive index monomer was introduced has a limitation in increasing refractive index or thermal resistance, and the polycarbonate/acrylic alloy resin does not easily express flame resistance by adding a small amount of flame retardant, and is degraded in mechanical properties including thermal resistance when the flame retardant is added.

### SUMMARY OF THE INVENTION

The present invention is directed to providing an environmentally friendly flame-resistant (meth)acrylic copolymer, which can have a high refractive index and excellent flame resistance, transparency, scratch resistance, impact resistance and thermal resistance, a method of preparing the same, a thermoplastic resin composition including the same, and a molded product including the same.

In accordance with the present invention, a (meth)acrylic copolymer is a copolymer of a monomer mixture including a phosphorus-based (meth)acrylic monomer represented by Formula 1, and a monofunctional unsaturated monomer:

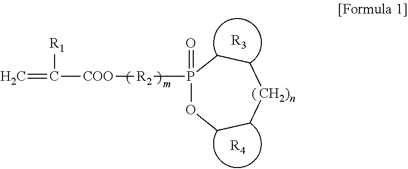

wherein R₁ is hydrogen or methyl, R₂ is a substituted or unsubstituted C1-C20 hydrocarbon group, R₃ and R₄ are the same or different and are each independently a substituted or unsubstituted C6-C20 cyclic hydrocarbon group, m is an integer from 1 to 10, and n is an integer from 0 to 5.

In one embodiment, the (meth)acrylic copolymer can include the phosphorus-based (meth)acrylic monomer in an amount of about 1 to about 50 wt %, and the monofunctional unsaturated monomer in an amount of about 50 to about 99 wt %.

Examples of the monofunctional unsaturated monomer may include without limitation C1-C8 alkyl(meth)acrylates; unsaturated carboxylic acids such as (meth)acrylic acid; acid anhydrides such as maleic anhydride; (meth)acrylates including a hydroxyl group; (meth)acrylamides; unsaturated nitriles; allyl glycidyl ethers; glycidyl methacrylates; aromatic vinyl-based monomers; and the like, and combinations thereof.

In one embodiment, the (meth)acrylic copolymer may have a weight average molecular weight of about 5,000 to about 500,000 g/mol.

In one embodiment, the (meth)acrylic copolymer may have a refractive index at a thickness of 2.5 mm of about 1.490 to about 1.590.

In one embodiment, the (meth)acrylic copolymer may have a flame retardancy measured with respect to a 3.2 mm thick sample according to UL94 of V2 or more.

In accordance with the present invention, a method of preparing the (meth)acrylic copolymer includes performing polymerization by adding a polymerization initiator to a monomer mixture including the phosphorus-based (meth)acrylic monomer represented by Formula 1, and the monofunctional unsaturated monomer.

In one embodiment, the polymerization initiator may be a radical polymerization initiator, and the polymerization may be suspension polymerization.

The suspension polymerization may be performed in the presence of a suspension stabilizer and a chain transfer agent.

In accordance with the present invention, a thermoplastic resin composition includes a polycarbonate resin and the (meth)acrylic copolymer.

In one embodiment, the thermoplastic resin composition may include the polycarbonate resin in an amount of about 50 to about 99 wt %, and the (meth)acrylic copolymer in an amount of about 1 to about 50 wt %.

In one embodiment, the thermoplastic resin composition may further include a rubber-modified vinyl-based graft copolymer resin.

The rubber-modified vinyl-based graft copolymer resin may have a structure in which a shell is formed by grafting an unsaturated monomer to a rubber core. Examples of the unsaturated monomer may include without limitation C1-C12 alkyl(meth)acrylates, acid anhydrides, C1-C12 alkyl and/or phenyl nucleus-substituted maleimides, and the like, and combinations thereof.

In one embodiment, the thermoplastic resin composition may further include a phosphorus-based flame retardant.

In one embodiment, the thermoplastic resin composition may have a flame retardancy measured with respect to a 3.2 mm thick sample according to UL94 of V2 or more.

In one embodiment, the thermoplastic resin composition may have a total luminous transmittance measured with respect to a 2.5 mm thick sample according to ASTM D1003 of about 85% or more.

In one embodiment, the thermoplastic resin composition may have a Vicat softening temperature (VST) measured by ASTM D1525 of about 85 to about 140° C.

In one embodiment, the thermoplastic resin composition may have a scratch width obtained by a ball-type scratch profile (BSP) test of about 180 to about 300 μm.

In accordance with the present invention, a molded product includes the (meth)acrylic copolymer.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

A (meth)acrylate copolymer according to the present invention is a copolymer of a monomer mixture including a phosphorus-based (meth)acrylic monomer represented by Formula 1, and a monofunctional unsaturated monomer.

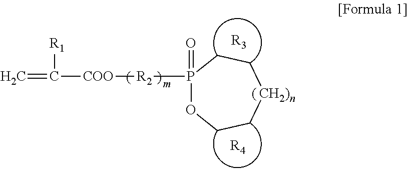

In Formula 1,

R₁ is hydrogen or methyl, R₂ is a substituted or unsubstituted C1-C20 hydrocarbon group, for example, a substituted or unsubstituted linear or branched C1-C20 alkylene group, C3-C20 cyclic group, or a substituted or unsubstituted C6-C20 arylene group, as another example a substituted or unsubstituted linear or branched C1-C10 alkylene group, a C3-C10 cyclic group, or a substituted or unsubstituted C6-C10 arylene group, and as yet another example a linear C1-C4 alkylene group;

R₃ and R₄ are the same or different and are each independently a substituted or unsubstituted C6-20 cyclic hydrocarbon group, for example, a substituted or unsubstituted C6-C20 cycloalkyl group or aryl group, and as another example a substituted or unsubstituted C6-C10 aryl group;

m is an integer from 1 to 10, and

n is an integer from 0 to 5.

As used here, when n is 0, this means that a single bond is formed, and a phosphorus-containing heterocyclic group forms a hexagonal ring.

Unless specifically described otherwise in the specification, “(meth)acryl” includes both “acryl” and “methacryl.” For example, “(meth)acrylate” includes both “acrylate” and “methacrylate.” In addition, “hydrocarbon group” refers to a saturated or unsaturated linear, branched or cyclic hydrocarbon group, the “substitution” refers to substitution of a hydrogen atom of a compound with a halogen atom (F, Cl, Br or I), a hydroxyl group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C1-C20 alkyl group, a C2-C20 alkenyl group, a C2-C20 alkynyl group, a C1-C20 alkoxy group, a C6-C30 aryl group, a C6-C30 aryloxy group, a C3-C30 cycloalkyl group, a C3-C30 cycloalkenyl group, a C3-C30 cycloalkynyl group, or a combined substituent thereof.

A particular example of the phosphorus-based (meth)acrylic monomer used in the present invention may be, but is not limited to, 9,10-dihydro-9-oxa-10-phosphaphenanthrene-10-oxy methyl methacrylate (DOPO-MA).

The phosphorus-based (meth)acrylic monomer may have a refractive index of, for example, about 1.550 to about 1.690, and as another example about1.590 to about 1.660. In this range, a (meth)acrylic copolymer having a high refractive index may be obtained.

The meth)acrylic copolymer can include the phosphorus-based (meth)acrylic monomer in an amount of about 1 to about 50 wt %, for example about 5 to about 40 wt %, based on the total weight of the monomer mixture. In some embodiments, the (meth)acrylic copolymer can include the phosphorus-based (meth)acrylic monomer in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the phosphorus-based (meth)acrylic monomer can be in a range from about any of the foregoing amounts to about any other of the foregoing amounts.

In this range, a (meth)acrylic copolymer having excellent flame resistance may be obtained with minimal or no degradation of other physical properties.

The monofunctional unsaturated monomer used in the present invention is a monomer containing one unsaturated group. Examples of the monofunctional unsaturated monomer can include without limitation C1-C8 alkyl(meth)acrylates; unsaturated carboxylic acids such as (meth)acrylic acid; acid anhydrides such as maleic anhydride; (meth)acrylates including a hydroxyl group; (meth)acrylamides; unsaturated nitriles; allylglycidyl ethers; glycidyl methacrylates; aromatic vinyl-based monomers; and the like, which may be used alone or a combination of at least two thereof.

Examples of the monofunctional unsaturated monomer can include without limitation methyl methacrylate, ethyl methacrylate, propyl methacrylate, butyl methacrylate, methylacrylate, ethyl acrylate, propyl acrylate, butyl acrylate, 2-ethylhexyl acrylate, acrylic acid, methacrylic acid, maleic anhydride, 2-hydroxyethyl acrylate, 2-hydroxypropyl acrylate, monoglycerol acrylate, acrylamide, methacrylamide, acrylonitrile, methacrylonitrile, allyl glycidyl ether, glycidyl methacrylate, styrene, α-methylstyrene, and the like, and combinations thereof In exemplary embodiments, C1-C8 alkyl(meth)acrylate, and as another example, C1 to C4 alkyl(meth)acrylate can be used. In this case, excellent scratch resistance and transparency may be achieved.

In one embodiment, as the monofunctional unsaturated monomer, a mixture of methacrylate and acrylate may be used. In this case, a weight ratio of the methacrylate and the acrylate (methacrylate:acrylate) may be about 15:1 to about 45:1. In this range, excellent thermal stability and flowability may be obtained.

The (meth)acrylic copolymer can include the monofunctional unsaturated monomer in an amount of about 50 to about 99 wt %, for example about 60 to about 95 wt %, based on the total weight of the monomer mixture. In some embodiments, the (meth)acrylic copolymer can include the monofunctional unsaturated monomer in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the monofunctional unsaturated monomer can be in a range from about any of the foregoing amounts to about any other of the foregoing amounts.

In this range, an excellent balance of properties such as scratch resistance, flowability, transparency and/or flame resistance may be obtained.

In addition, the (meth)acrylic copolymer according to the present invention may further include at least one additive. Examples of the additives can include without limitation flame retardants, surfactants, nucleating agents, coupling agents, filler, plasticizers, impact reinforcing agents, lubricants, antibacterial agents, release agents, thermal stabilizers, antioxidants, photostabilizers, compatibilizers, inorganic additives, antistatic agents, pigments, dyes, and the like, and combinations thereof. These additives may be added during polymerization, or added during a pellet forming process (extrusion) to be included in the copolymer, but a method thereof and an added amount are not particularly limited.

Examples of the antioxidant can include without limitation octadecyl 3-(3,5-di-tertiary-butyl-4-hydrophenyl)propionate, triethylene glycol-bis-3(3-tertiary-butyl-4-hydroxy-5-methylphenyl)propionate, 2,6-di-tertiary-butyl-4-methyl phenol, 2,2′-methylenebis(4-methyl-6-tertiarybutyl phenol), tri(2,4-di-tertiary-butylphenyl)phosphate, normal-octadecyl-3(3,5-di-tertiary-butyl-4-hydrophenyl)propionate, 1,3,5-tri(3,5-di-tertiary-butyl-4-hydroxybenzyl) isocyanate, 3-(3,5-di-tertiary-butyl-4-hydroxyphenyl)propionate, distearyl-thio-dipropionate, lauryl-thio-propionate methane, di-phenyl-isooctylphosphate, and the like, and combinations thereof.

The (meth)acrylic copolymer of the present invention may have a weight average molecular weight of about 5,000 to about 500,000 g/mol, for example about 10,000 to about 250,000 g/mol, and as yet another example about 20,000 to about 100,000. In this range, the copolymer may have excellent impact resistance.

The (meth)acrylic copolymer may have a refractive index at a thickness of 2.5 mm of about 1.490 to about 1.590, for example about 1.492 to about 1.550, and have a flame retardancy measured with respect to a 3.2 mm thick sample according to a UL94 evaluation method of V2 or more, for example, V2 to V0.

In addition, the (meth)acrylic copolymer may have a total luminous transmittance measured with respect to a 2.5 mm thick sample according to ASTM D1003 of about 90% or more, for example about 91 to about 98%.

The (meth)acrylic copolymer according to the present invention may be prepared by a conventional polymerization method known in the field of preparing a copolymer, for example, bulk polymerization, emulsion polymerization, or suspension polymerization, for example, a preparation method including performing polymerization by adding a polymerization initiator to the monomer mixture.

In one embodiment, the polymerization initiator may be a radical polymerization initiator, the polymerization may be suspension polymerization in consideration of a refractive index, and the suspension polymerization may be performed in the presence of a suspension stabilizer and a chain transfer agent. That is, the (meth)acrylic copolymer of the present invention may be prepared (suspension-polymerized) by preparing a reaction mixture solution by adding a radical polymerization initiator and a chain transfer agent to the monomer, and adding the prepared reaction mixture solution to an aqueous solution in which a suspension stabilizer is dissolved. Here, the additive may be further added.

As the polymerization initiator, a conventional radical polymerization initiator known in the field of polymerization, for example, octanoyl peroxide, decanoyl peroxide, lauroyl peroxide, benzoyl peroxide, monochlorobenzoyl peroxide, dichlorobenzoyl peroxide, p-methylbenzoyl peroxide, tert-butyl perbenzoate, azobisisobutyronitrile, azobis-(2,4-dimethyl)-valeronitrile, and the like, may be used, but the present invention is not limited thereto. These may be used alone or in a combination of at least two thereof. The polymerization initiator may be included in an amount of about 0.01 to about 10 parts by weight, for example about 0.03 to about 5 parts by weight with respect to about 100 parts by weight of the monomer mixture.

The chain transfer agent may be used to control weight average molecular weight of the (meth)acrylate copolymer, and to enhance thermal stability. The weight average molecular weight may be controlled by the amount of the polymerization initiator included in the monomer mixture. However, when a polymerization reaction is stopped by a chain transfer agent, a terminal end of the chain becomes a second carbon structure. It has a higher binding strength than a terminal end of a chain having a double bond formed when a chain transfer agent is not used. Accordingly, the addition of a chain transfer agent may enhance thermal stability, and thus an optical characteristic of the (meth)acrylate copolymer may be enhanced.

The chain transfer agent may be a conventional chain transfer agent known in the field of polymerization, such as but not limited to, a CH₃(CH₂)ₙSH (n is an integer from 1 to 20)-type alkyl mercaptan including n-butyl mercaptan, n-octyl mercaptan, n-dodecyl mercaptan, t-dodecyl mercaptan, isopropyl mercaptan and n-amyl mercaptan; a halogen compound such as carbon tetrachloride; an aromatic compound such as an α-methylstyrene dimer and/or α-ethylstyrene dimer, and the like. These may be used alone or in a combination of at least two thereof. Generally, while an amount of the chain transfer agent used varies depending on its kind, the chain transfer agent may be used in an amount of about 0.01 to about 10 parts by weight, for example about 0.02 to about 5 parts by weight with respect to about 100 parts by weight of the monomer mixture. In this range, the copolymer may have excellent thermal resistance, and also can have excellent mechanical properties since the chain transfer agent can prevent an excessive decrease in molecular weight of the polymerization product.

In the method of preparing the (meth)acrylic copolymer of the present invention, a conventional auxiliary suspension stabilizer may be used along with the suspension stabilizer.

Examples of the suspension stabilizer may include, but are not limited to, organic suspension stabilizers such as polyalkylacrylate-acrylic acid, polyolefin-maleic acid, poylvinylalcohol, and cellulose, inorganic suspension stabilizers such as tricalcium phosphate, and the like, and combinations thereof.

Examples of the suspension stabilization adjuvant can include without limitation disodium hydrogen phosphate, sodium dihydrogen phosphate, and the like, and combinations thereof. Sodium sulfate may be added to control a solubility characteristic of an aqueous polymer or monomer.

In the method of preparing the (meth)acrylic copolymer of the present invention, polymerization temperature and polymerization time may be suitably controlled. For example, the polymerization may be performed at a temperature of about 65 to about 125° C., for example about 70 to about 120° C. for about 2 to about 8 hours.

After the polymerization is done, a particle-type (meth)acrylic copolymer may be obtained through cooling, washing, dehydration, and drying.

The thermoplastic resin composition according to the present invention includes a (A) polycarbonate resin, and the (B) (meth)acrylic copolymer.

(A) Polycarbonate Resin

As a polycarbonate resin used in the present invention, a conventional polycarbonate resin may be used. In one embodiment, a polycarbonate resin prepared by reacting a dihydric phenol-based compound and phosgene in the presence of a molecular weight control agent and a catalyst according to a conventional preparation method may be used. In addition, in another embodiment, the polycarbonate resin may be prepared using an ester exchange reaction between a dihydric phenol-based compound and a carbonate precursor such as diphenylcarbonate.

In the method of preparing such a polycarbonate, the dihydric phenol-based compound may be a bisphenol-A based compound, for example 2,2-bis(4-hydroxyphenyl)propane (referred to as “bisphenol-A”). Here, the bisphenol-A may be partially or totally replaced with a different kind of dihydric phenol-based compound. Other available kinds of dihydric phenol-based compounds may include without limitation hydroquinone, 4,4′-dihydroxydiphenyl, bis(4-hydroxyphenyl)methane, 1,1-bis(4-hydroxyphenyl)cyclohexane, 2,2-bis(3,5-dimethyl-4-hydroxyphenyl)propane, bis(4-hydroxyphenyl)sulfide, bis(4-hydroxyphenyl)sulfone, bis(4-hydroxyphenyl)sulfoxide, bis(4-hydroxyphenyl)ketone or bis(4-hydroxyphenyl)ether, halogenated bisphenols such as 2,2-bis(3,5-dibromo-4-hydroxyphenyl)propane, and the like, and combinations thereof.

However, a kind of the dihydric phenol-based compound available to prepare the polycarbonate resin is not limited thereto, and thus the polycarbonate resin may be prepared using an optional dihydric phenol-based compound.

In addition, the polycarbonate resin may be a homopolymer using one kind of dihydric phenol-based compound, a copolymer using at least two kinds of dihydric phenol-based compounds, or a mixture thereof.

Moreover, conventionally, the polycarbonate resin may be in the form of a linear polycarbonate resin, a branched polycarbonate resin or a polyestercarbonate copolymer resin. As the polycarbonate resin included in the thermoplastic resin composition of the present invention, any one of a linear polycarbonate resin, a branched polycarbonate resin and a polyestercarbonate copolymer resin, or a combination thereof, may be used without limitation to a specific type.

As the linear polycarbonate resin, for example, a bisphenol-A based polycarbonate resin may be used, and as the branched polycarbonate resin, for example, one prepared by a reaction of a multifunctional aromatic compound such as trimellitic anhydride or trimellitic acid with a dihydric phenol-based compound and a carbonate precursor may be used. In addition, as the polyestercarbonate copolymer resin, for example, one prepared by a reaction of a bifunctional carboxylic acid with a dihydric phenol and a carbonate precursor may be used. Other than these, a conventional linear polycarbonate resin, a branched polycarbonate resin and/or a polyestercarbonate copolymer resin may be used without limitation.

In the present invention, the polycarbonate resin may be used alone or mixed with at least two resins having different molecular weights.

The thermoplastic resin composition can include the polycarbonate resin in an amount of about 50 to about 99 wt %, for example about 55 to about 95 wt %, and as another example about 60 to about 90 wt %, based on the total weight of a base resin including the polycarbonate resin and the (meth)acrylic copolymer ((A)+(B)). In some embodiments, the thermoplastic resin composition can include the polycarbonate resin in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the polycarbonate resin can be in a range from about any of the foregoing amounts to about any other of the foregoing amounts.

In this range, excellent mechanical properties and a balance of scratch resistance may be obtained.

(B) (Meth)acrylic Copolymer

In the thermoplastic resin composition according to the present invention, the (meth)acrylic copolymer is used.

The thermoplastic resin composition can include the (meth)acrylic copolymer in an amount of about 1 to about 50 wt %, for example about 5 to about 45 wt %, and as another example about 10 to about 40 wt %, based on the total weight of the base resin including (A)+(B). In some embodiments, the thermoplastic resin composition can include the (meth)acrylic copolymer in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the (meth)acrylic copolymer can be in a range from about any of the foregoing amounts to about any other of the foregoing amounts.

In this range, the scratch resistance may be sufficiently improved, and degradation in impact resistance and mechanical properties may be minimized or prevented.

The thermoplastic resin composition according to the present invention, as necessary, may further include a (C) rubber-modified vinyl-based graft copolymer and/or a (D) phosphorus-based flame retardant.

(C) Rubber-Modified Vinyl-Based Graft Copolymer

A rubber-modified vinyl-based graft copolymer used in the present invention has a core-shell graft copolymer structure, in which a shell is formed by grafting an unsaturated monomer to a core structure of a rubber, and serves as an impact reinforcing agent in the thermoplastic resin composition.

Examples of the rubber can include without limitation C4-C6 diene-based rubbers, acrylate-based rubbers, silicone-based rubbers, and the like, and mixtures thereof In terms of structural stability, a silicone-based rubber may be used alone, or a combination of a silicone-based rubber and an acrylate-based rubber can be used.

Examples of acrylate type monomers that can be used to make the acrylate-based rubber can include without limitation (meth)acrylate monomers such as methyl(meth)acrylate, ethyl(meth)acrylate, n-propyl(meth)acrylate, n-butyl(meth)acrylate, 2-ethylhexyl(meth)acrylate, hexyl(meth)acrylate, and the like, and combinations thereof Here, a curing agent such as ethyleneglycol di(meth)acrylate, propyleneglycol di(meth)acrylate, 1,3-butyleneglycol di(meth)acrylate, 1,4-butyleneglycol di(meth)acrylate, allyl(meth)acrylate, triallyl cyanurate, and the like, and combinations thereof may be further used.

The silicone-based rubber is prepared from a cyclosiloxane. Examples of the cyclosiloxane can include without limitation hexamethyl cyclotrisiloxane, octamethyl cyclotetrasiloxane, decamethyl cyclopentasiloxane, dodecamethyl cyclohexasiloxane, trimethyltriphenyl cyclotrisiloxane, tetramethyltetraphenyl cyclotetrasiloxane, octaphenyl cyclotetrasiloxane, and the like, and combinations thereof Here, a curing agent such as trimethoxymethylsilane, triethoxyphenylsilane, tetramethoxysilane, tetraethoxysilane, and the like, and combinations thereof may be further used.

The rubber-modified vinyl-based graft copolymer can include the rubber in an amount of about 50 to about 95 parts by weight, for example about 60 to about 90 parts by weight, as another example about 70 to about 85 parts by weight with respect to about 100 parts by weight of the rubber-modified vinyl-based graft copolymer. In some embodiments, the rubber-modified vinyl-based graft copolymer can include the rubber in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 parts by weight. Further, according to some embodiments of the present invention, the amount of the rubber can be in a range from about any of the foregoing amounts to about any other of the foregoing amounts.

In this range, compatibility with the resin can be excellent, and thus an excellent impact reinforcing effect may be exhibited.

The rubber may have an average particle diameter of about 0.1 to about 1 μm, for example about 0.4 to about 0.9 μm. In this range, a balance between impact resistance and coloring properties may be maintained.

Examples of the unsaturated monomer grafted to the rubber can include without limitation unsaturated compounds such as C1-C12 alkyl(meth)acrylates, (meth)acrylates, acid anhydrides, C1-C12 alkyl and/or phenyl nucleus-substituted maleimides, and the like, and combinations thereof.

Examples of the alkyl(meth)acrylates may include without limitation methyl methacrylate, ethyl methacrylate, propyl methacrylate, and the like, and combinations thereof.

Examples of the acid anhydride may include without limitation carboxylic acid anhydrides such as maleic anhydride and/or itaconic anhydride.

The rubber-modified vinyl-based graft copolymer can include the grafted unsaturated monomer in an amount of about 5 to about 50 parts by weight, for example about 10 to about 40 parts by weight, and as another example about 15 to about 30 parts by weight with respect to about 100 parts by weight of the rubber-modified vinyl-based graft copolymer. In some embodiments, the rubber-modified vinyl-based graft copolymer can include the grafted unsaturated monomer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 parts by weight. Further, according to some embodiments of the present invention, the amount of the grafted unsaturated monomer can be in a range from about any of the foregoing amounts to about any other of the foregoing amounts.

In this range, excellent compatibility with the resin, and an excellent impact reinforcing effect may be exhibited.

The rubber-modified vinyl-based graft copolymer resin may be used in an amount of about 0 to about 30 parts by weight, for example about 3 to 20 parts by weight with respect to about 100 parts by weight of the base resin including (A)+(B). In some embodiments, the thermoplastic resin composition can include the rubber-modified vinyl-based graft copolymer resin in an amount of 0 (the graft copolymer is not present), about 0 (the graft copolymer is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the rubber-modified vinyl-based graft copolymer resin can be in a range from about any of the foregoing amounts to about any other of the foregoing amounts.

In this range, the impact reinforcing effect may be obtained, and mechanical strengths such as tensile strength, flexural strength, and flexural modulus may be improved.

(D) Phosphorus-Based Flame Retardant

A phosphorus-based flame retardant used in the present invention is added to further ensure flame resistance, and may be, for example, a conventional phosphorus-containing flame retardant. Examples of the phosphorus-containing flame retardant can include without limitation phosphates, phosphonates, phosphinates, phosphine oxides, phosphazenes, metal salts thereof, and the like, and combinations thereof.

In one embodiment, the phosphorus-based flame retardant may be a compound represented by Formula 2:

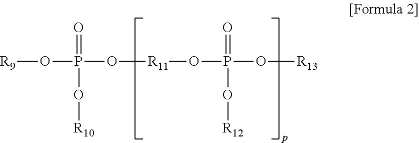

wherein R₉, R₁₀, R₁₂ and R₁₃ are the same or different and are each independently C6-C20 aryl or C1-C10 alkyl-substituted C6-C20 aryl, R₁₁ is derived from a dialcohol of resorcinol, hydroquinol, bisphenol-A, or bisphenol-S, and p is an integer from 0 to 10.

In Formula 2, i) when p is 0, the compound is triphenyl phosphate, tricresyl phosphate, cresyl diphenyl phosphate, trixylyl phosphate, tri(2,4,6-trimethylphenyl)phosphate, tri(2,4-ditertiarybutylphenyl)phosphate or tri(2,6-ditertiarybutylphenyl)phosphate, ii) when p is 1, the compound is resorcinol bis(diphenylphosphate), hydroquinol bis(diphenylphosphate), bisphenol-A bis(diphenylphosphate), resorcinol bis(2,6-ditertiarybutylphenyl phosphate), or hydroquinol bis(2,6-diethylphenyl phosphate), and iii) when p is 2, the compound is present in the form of an oligomer-type mixture.

In another embodiment, the phosphorus-based flame retardant may be a compound represented by Formula 3:

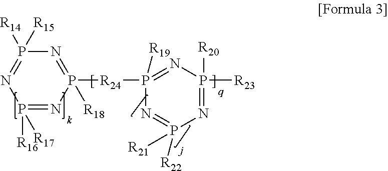

wherein R₁₄, R₁₅, R₁₆, R₁₇, R₁₈, R₁₉, R₂₀, R₂₁, R₂₂, and R₂₃ are the same or different and are each independently C1-C6 alkyl, C6-C20 aryl, C1-C6 alkyl-substituted C6-C20 aryl, C6-C20 aralkyl, C1-C6 alkoxy, C6-C20 aryloxy, an amino group or a hydroxyl group, R₂₄ is C6-C30 dioxyaryl or a derivative of alkyl-substituted C6-C30 dioxyaryl, q is a number average polymerization degree, an average value of q is 0.3 to 3, and k and j are integers from 0 to 10. Here, the alkoxy group or aryloxy group of Formula 3 may be substituted with an alkyl group, an aryl group, an amino group, or a hydroxyl group.

The thermoplastic resin composition according to the present invention may further include one or more additives. Examples of the additives can include without limitation flame retardants, surfactants, nucleating agents, coupling agents, filler, plasticizers, impact reinforcing agents, lubricants, antibacterial agents, release agents, thermal stabilizers, antioxidants, photostabilizers, compatibilizers, inorganic additives, antistatic agents, pigments, dyes, and the like, which may be used alone or in a combination of at least two thereof, as necessary. These additives may be included in the (meth)acrylic copolymer of the thermoplastic resin composition during polymerization of the (meth)acrylic copolymer, or may be included in the entire thermoplastic resin composition during a conventional pellet forming process (extrusion) of the thermoplastic resin composition, but a method is not particularly limited. When the additive is used, a content thereof may be, but is not limited to, about 0.001 to about 20 parts by weight with respect to about 100 parts by weight of the base resin including (A)+(B).

The thermoplastic resin composition of the present invention may have a flame retardancy measured with respect to a 3.2 mm thick sample according to UL94 of V2 or more, for example, V2 to V0.

The thermoplastic resin composition may have a total luminous transmittance measured with respect to a 2.5 mm thick sample according to ASTM D1003 of about 85% or more, for example about 86 to about 98%.

The thermoplastic resin composition may have a VST measured according to ASTM D1525 of about 85 to about 140° C., for example about 90 to about 135° C.

In addition, the thermoplastic resin composition may have a scratch width measured by a BSP test of about 180 to about 300 μm, for example about 230 to about 290 μm.

The (meth)acrylic copolymer and thermoplastic resin composition according to the present invention may form a molded product. A molding method to prepare the molded product may be, but is not limited to, extrusion, injection and/or casting. The molding method is widely known to one of ordinary skill in the art. For example, the (meth)acrylic copolymer may be prepared in the form of pellets by mixing the components described herein and additives as necessary and melt-extruding the mixture in an extruder, and then an injection and/or compression-molded product may be prepared using the pellets.

In addition, the thermoplastic resin composition may be prepared in the form of pellets by simultaneously mixing components of the thermoplastic resin composition of the present invention with other additives, and then melt-extruding the mixture in an extruder, and then a plastic injection and/or compression-molded product may be prepared using the pellets.

Hereinafter, the components and functions of the present invention will be described in further detail with reference to the following examples of the present invention. However, the examples are merely provided as exemplary examples, and should not be construed as limiting the present invention.

### EXAMPLES

### Examples 1-5

According to a composition of Table 1, a monomer mixture solution is prepared by mixing a monomer mixture including a (a) 9,10-dihydro-9-oxa-10-phosphapenanthrene-10-oxymethyl methacrylate monomer as a phosphorus-based (meth)acrylic monomer and a (b-1) methyl methacrylate monomer and a (b-2) methyl acrylate monomer as a monofunctional unsaturated monomer, 0.5 parts by weight of azobisisobutyronitrile (AIBN) as a polymerization initiator, and 0.5 parts by weight of n-octyl mercaptan as a chain transfer agent with respect to 100 parts by weight of the monomer mixture. 130 parts by weight of ion-exchange water, 0.2 parts by weight of poly(ethylacrylate/methylacrylic acid) (weight average molecular weight: 1,000,000 g/mol or more) as a suspension stabilizer, and, 0.5 parts by weight of disodiumhydrogen phosphate and sodium sulfate as auxiliary suspension stabilizers with respect to 100 parts by weight of the monomer mixture are added and stirred in a stainless steel high-pressure reaction vessel equipped with a stirrer. The monomer mixture solution is added to the aqueous solution in which the suspension stabilizer is dissolved and stirred, an inside of the reaction vessel is filled with an inert gas such as nitrogen, polymerization is performed at 72° C. for 3 hours and at 110° C. for 2 hours, and then the reaction is ended. After the end of the reaction, a (meth)acrylic copolymer particle is obtained through washing, dehydration and drying. Physical properties are measured using the particle and a sample obtained by extruding or injecting the particle by the following method of evaluating physical properties, and the results are shown in Table 1.

### Comparative Example 1

A (meth)acrylic copolymer particle is obtained by the same method as described in Example 1, except that a monomer mixture composed of 97.5 wt % of a (b-1) methyl methacrylate monomer and 2.5 wt % of a (b-2) methyl acrylate monomer is used instead of the monomer mixture, and 0.3 parts by weight of AIBN and 0.3 parts by weight of n-octyl mercaptan are added as polymerization initiators with respect to 100 parts by weight of the monomer. Physical properties are measured using the particle and a sample obtained by extruding or injecting the particle by the following method of evaluating physical properties, and the results are shown in Table 1.

### Comparative Examples 2-3

A (meth)acrylic copolymer particle is obtained by the same method as described in Examples 1 and 5, except that as a phosphorus-based (meth)acrylic monomer, (c) diethyl(methacryloyl oxymethyl)phosphonate is used instead of the (a) 9,10-dihydro-9-oxa-10-phosphapenanthrene-10-oxymethyl methacrylate monomer. Physical properties are measured using the particle and a sample obtained by extruding or injecting the particle by the following method of evaluating physical properties, and the results are shown in Table 1.

Method of Preparing Sample

100 parts by weight of (meth)acrylic copolymer particles of Examples 1-5 and Comparative Examples 1-3 and 0.1 parts by weight of a hindered phenol-based thermal stabilizer are added, and then melted, blended and extruded, thereby preparing pellets. Here, the extrusion is performed using a biaxial extruder having L/D of 29 and a diameter of 45 mm, and the prepared pellets are dried at 80° C. for 6 hours, and then injected in a 6 oz. injector to form samples.

Specifications of each component used in Examples 6-11 and Comparative Examples 4-10 are as follows:

(A) Polycarbonate-Based Resin

A bisphenol-A type linear polycarbonate resin (PANLITE L-1250WP, TEIJIN, Japan) having a weight average molecular weight of 25,000 g/mol is used.

(B) (Meth)acrylic Copolymer

(B1) A copolymer is prepared using 20 wt % of a (B1) 9,10-dihydro-9-oxa-10-phosphapenanthrene-10-oxy methyl methacrylate monomer and 80 wt % of a methylmethacrylate monomer by a conventional suspension polymerization method, and a weight average molecular weight of the prepared copolymer is 40,000 g/mol.

(B2) A polymethylmethacrylate resin (L84, LG MMA) having a weight average molecular weight of 92,000 g/mol is used.

(B3) A copolymer is prepared using 30 wt % of a phenyl methacrylate monomer having a refractive index of 1.570 and 70 wt % of a methylmethacrylate monomer by a conventional suspension polymerization method, and the prepared copolymer has a refractive index of 1.530 and a weight average molecular weight of 40,000 g/mol.

(C) Rubber-Modified Vinyl-Based Graft Copolymer

METABLEN® C-930A (MITSUBISHI RAYON, Japan) in which a methylmethacrylate monomer is grafted to a butadiene/acryl-based rubber complex is used.

(D) Phosphorus-Based Flame Retardant

Resorcinol bis(diphenylphosphate) is used.

### Examples 6-11 and Comparative Examples 4-10

Pellets are prepared by adding the respective components in the amounts described in the following Tables 2 and 3, adding 0.1 parts by weight of a hindered phenol-based thermal stabilizer, and melting, blending and extruding the mixture. Here, the extrusion is performed using a biaxial extruder having L/D of 29 and a diameter of 45 mm, and the prepared pellets are dried at 80° C. for 6 hours, and then injected in a 6 oz. injector to form samples. Physical properties of the prepared samples are evaluated by the following methods, and the results are shown in Tables 2 and 3.

Methods of Evaluation of Physical Properties

(1) A weight average molecular weight (Mw) is measured using gel permeation chromatography (GPC) (unit: g/mol).

(2) A refractive index is measured using a refractometer (DR-A1, ATAGO) at 20° C., and a thickness of a sample is 2.5 mm.

(3) A flame retardancy is measured by a UL94 vertical test method using samples having a thickness of 3.2 mm (Examples 1-5, Comparative Examples 1-3) or 1.5 mm (Examples 6-11, Comparative Examples 4-10), and the results are shown in Tables 1 to 3.

(4) A transparency is evaluated by a haze (%) and a total luminous transmittance (%) of an exterior of a molded product sample prepared to have a thickness of 2.5 mm. To evaluate the transparency of the sample, the total luminous transmittance (TT) and a haze value are measured using a haze meter (NDH 2000, Nippon Denshoku). Here, as the TT is higher and the haze is lower, the transparency is evaluated as excellent.

(5) A scratch resistance is measured by a BSP test. A scratch having a length of 10 to 20 mm is made using a spherical metal tip having a diameter of 0.7 mm on a surface of a sample having a size of 90 mm (L)×50 mm (W)×2.5 mm (T) under a load of 1,000 g at a scratching speed of 75 mm/min. A scratch profile of the sample surface is scanned with a 2 μm metal stylus tip using a touch-sensitive surface profiler (XP-1, Ambios) to evaluate a scratch width (μm) which is a barometer of the scratch resistance. Here, as the measured scratch width is decreased, the scratch resistance is increased.

(6) An impact strength (Izod, Unit: kg·cm/cm) is evaluated by forming a notch in a ⅛″ Izod specimen according to an evaluation method specified in ASTM D256.

(7) A VST (unit: ° C.) is measured according to an evaluation method specified in ASTM D1525 under a load of 5 kg at 50° C./hr.

(8) A melt flow index (MI) (unit: g/10 min) is measured according to ASTM D1238 at 250° C. under a load of 2.16 kg.

TABLE 1

| | | | Example | | | | | Comparative Example | | |
|---|---|---|---|---|---|---|---|---|---|---|
| | | | 1 | 2 | 3 | 4 | 5 | 1 | 2 | 3 |
| Monomer | (a) (wt %) | | 10.0 | 20.0 | 20.0 | 30 | 20.0 | — | — | — |
| mixture | (b-1) (wt %) | | 87.5 | 77.5 | 77.5 | 67.5 | 80.0 | 97.5 | 87.5 | 67.5 |
| | (b-2) (wt %) | | 2.5 | 2.5 | 2.5 | 2.5 | — | 2.5 | 2.5 | 2.5 |
| | (c) (wt %) | | — | — | — | — | — | — | 10.0 | 30.0 |
| Physical | Mw (×1,000) | | 40 | 40 | 120 | 120 | 120 | 130 | 120 | 120 |
| property | Refractive | | 1.4931 | 1.4977 | 1.4977 | 1.5032 | 1.4989 | 1.4890 | 1.4844 | 1.4752 |
| | Index | | | | | | | | | |
| | Flame | | V2 | V1 | V1 | V0 | V1 | Fail | Fail | V2 |
| | Resistance | | | | | | | | | |
| | Haze | | 1.3% | 1.5% | 1.4% | 1.2% | 1.2% | 1.0% | 2.3% | 3.1% |
| | Total | | 91.1% | 91.3% | 91.4% | 91.7% | 91.8% | 92.2% | 88.3% | 87.2% |
| | Luminous | | | | | | | | | |
| | Transmittance | | | | | | | | | |
| | BSP | Width | 205 | 215 | 220 | 235 | 210 | 180 | 200 | 230 |

| | | | | | | | | |
|---|---|---|---|---|---|---|---|---|
| Izod Impact | 1.9 | 1.8 | 2.8 | 2.7 | 2.5 | 3.1 | 2.8 | 2.7 |
| Strength | | | | | | | | |

TABLE 2

| | Example | | | | | |
|---|---|---|---|---|---|---|
| | 6 | 7 | 8 | 9 | 10 | 11 |
| (A) (wt %) | 70 | 80 | 70 | 80 | 80 | 80 |
| (B1) (wt %) | 30 | 20 | 30 | 20 | 20 | 20 |
| (C) (parts by weight) | — | — | — | 5 | 5 | 5 |
| (D) (parts by weight) | — | — | 20 | 20 | 10 | — |
| Izod Impact Strength | 2.6 | 5.1 | 2.4 | 8.1 | 9.3 | 17.0 |
| VST | 129.2 | 133.7 | 91.5 | 91.2 | 107.7 | 131.9 |
| MI | 7.8 | 5.2 | 38.4 | 18.0 | 8.6 | 4.3 |
| Flame Retardancy | V2 | V0 | V0 | V0 | V0 | V1 |
| BSP width | 262 | 265 | 241 | 270 | 276 | 280 |
| Total Luminous | 88.8 | 88.5 | 86.2 | 90.1 | 92.5 | 94.7 |
| Transmittance | | | | | | |
| Haze | 18.6 | 29.4 | 25.1 | 19.3 | 18.2 | 15.6 |

TABLE 3

| | Comparative Example | | | | | | |
|---|---|---|---|---|---|---|---|
| | 4 | 5 | 6 | 7 | 8 | 9 | 10 |
| (A) (wt %) | 70 | 80 | 80 | 80 | 80 | 100 | 100 |
| (B2) (wt %) | 30 | — | — | 20 | — | — | — |
| (B3) (wt %) | — | 20 | 20 | — | 20 | — | — |
| (C) (parts by weight) | — | — | 5 | 5 | 5 | — | 5 |
| (D) (parts by weight) | — | — | — | 20 | 20 | — | 20 |
| Izod Impact Strength | 4.2 | 3.4 | 16.8 | 9.3 | 6.2 | 73.1 | 63.1 |
| VST | 133.1 | 126.6 | 133.2 | 91.3 | 90.1 | 145.4 | 100.1 |
| MI | 6.1 | 17.1 | 14.8 | 14.9 | 33.0 | 6.3 | 23.1 |
| Flame Retardancy | Fail | Fail | Fail | V0 | V0 | V2 | V2 |
| BSP width | 253 | 267 | 285 | 274 | 276 | 332 | 307 |
| Total Luminous | 98.9 | 3.8 | 49.4 | 92.3 | 45.1 | 1.8 | 85.6 |
| Transmittance | | | | | | | |
| Haze | 12.1 | 87.2 | 51.3 | 13.7 | 53.8 | 88.5 | 27.2 |

From the results of Table 1, it can be seen that the (meth)acrylic copolymers (Examples 1-5) using the phosphorus-based (meth)acrylic monomer having the structure represented by Formula 1 have excellent transparency, a high refractive index of 1.4931 or more, and an excellent flame retardancy of V2 or more.

However, in Comparative Example 1 without using a phosphorus-based (meth)acrylic monomer, refractive index is 1.490 or less, scratch resistance is decreased, and flame retardancy is not observed. In addition, in Comparative Examples 2 and 3 using a conventional phosphorus-based (meth)acrylic monomer which is different from that of Formula 1, it can be seen that refractive index is 1.490 or less, and transparency and flame retardancy are decreased, compared with the Examples exemplifying the invention.

In addition, from the results shown in Tables 2 and 3, the thermoplastic resin compositions of the present invention (Examples 6-11) have excellent impact strengths, VSTs, scratch resistances and a balance of physical properties, and better transparency than those of Comparative Examples 4-10. Moreover, even though the phosphorus-based flame retardant is not included, flame retardancy is excellent at V2 or more.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A (meth)acrylic copolymer, which is a copolymer of a monomer mixture including a phosphorus-based (meth)acrylic monomer represented by Formula 1, and a monofunctional unsaturated monomer: 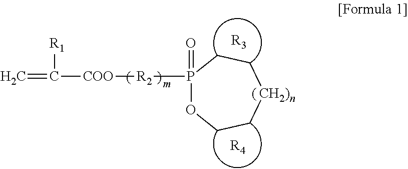
wherein R₁ is hydrogen or methyl, R₂ is a substituted or unsubstituted C1-C20 hydrocarbon group, R₃ and R₄ are the same or different and are each independently a substituted or unsubstituted C6-C20 cyclic hydrocarbon group, m is an integer from 1 to 10, and n is an integer from 0 to 5.

2. The copolymer according to claim 1, including the phosphorus-based (meth)acrylic monomer in an amount of about 1 to about 50 wt %, and the monofunctional unsaturated monomer in an amount of about 50 to about 99 wt %.

3. The copolymer according to claim 1, wherein the monofunctional unsaturated monomer comprises a C1-C8 alkyl(meth)acrylate; an unsaturated carboxylic acid; an acid anhydride; a (meth)acrylate including a hydroxyl group; a (meth)acrylamide; an unsaturated nitrile; an allyl glycidyl ether; a glycidyl methacrylate; an aromatic vinyl-based monomer, or a combination thereof.

4. The copolymer according to claim 1, wherein the (meth)acrylic copolymer has a weight average molecular weight of about 5,000 to about 500,000 g/mol.

5. The copolymer according to claim 1, wherein the (meth)acrylic copolymer has a refractive index at a thickness of 2.5 mm of about 1.490 to about 1.590.

6. The copolymer according to claim 1, wherein the (meth)acrylic copolymer has flame retardancy measured with respect to a 3.2 mm thick sample according to UL94 of V2 or more.

7. A method of preparing a (meth)acrylic copolymer, comprising:
performing polymerization by adding a polymerization initiator to a monomer mixture including a phosphorus-based (meth)acrylic monomer represented by Formula 1, and a monofunctional unsaturated monomer: 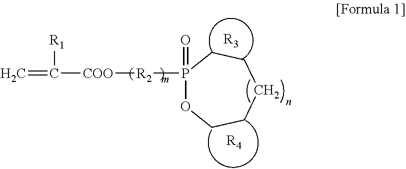
wherein R₁ is hydrogen or methyl, R₂ is a substituted or unsubstituted C1-C20 hydrocarbon group, R₃ and R₄ are the same or different and are each independently a substituted or unsubstituted C6-C20 cyclic hydrocarbon group, m is an integer from 1 to 10, and n is an integer from 0 to 5.

8. The method according to claim 7, wherein the polymerization initiator is a radical polymerization initiator, and the polymerization is suspension polymerization.

9. The method according to claim 8, wherein the suspension polymerization is performed in the presence of a suspension stabilizer and a chain transfer agent.

10. A thermoplastic resin composition, comprising:
a polycarbonate resin; and
the (meth)acrylic copolymer according to claim 1.

11. The composition according to claim 10, wherein the thermoplastic resin composition comprises about 50 to about 99 wt % of the polycarbonate resin and about 1 to about 50 wt % of the (meth)acrylic copolymer.

12. The composition according to claim 10, further comprising: a rubber-modified vinyl-based graft copolymer resin.

13. The composition according to claim 12, wherein the rubber-modified vinyl-based graft copolymer resin has a structure in which a shell is formed by grafting an unsaturated monomer to a rubber core, and the unsaturated monomer comprises a C1-C12 alkyl(meth)acrylate, acid anhydride, C1-C12 alkyl nucleus-substituted maleimide, phenyl nucleus-substituted maleimide, or a combination thereof.

14. The composition according to claim 10, further comprising: a phosphorus-based flame retardant.

15. The composition according to claim 10, which has a flame retardancy measured with respect to a 3.2 mm thick sample according to UL94 of V2 or more.

16. The composition according to claim 10, which has a total luminous transmittance measured with respect to a 2.5 mm thick sample according to ASTM D1003 of about 85% or more.

17. The composition according to claim 10, which has a Vicat softening temperature (VST) measured according to ASTM D1525 of about 85 to about 140° C.

18. The composition according to claim 10, which has a scratch width by a ball-type scratch profile test of about 180 to about 300 μm.

19. A molded product comprising the (meth)acrylic copolymer according to claim 1.
